(19) United States
(12) Patent Application Publication
(10) Pub. No.: US 2009/0224177 A1
(43) Pub. Date: Sep. 10, 2009

(54) COLOR CONVERSION MEMBER AND LIGHT EMITTING APPARATUS USING THE COLOR CONVERSION MEMBER

(75) Inventors: Junichi KINOMOTO, Tenri-shi (JP); Hajime SAITO, Matsuzaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 12/395,473

(22) Filed: Feb. 27, 2009

(30) Foreign Application Priority Data
Feb. 29, 2008 (JP) 2008-050180

(51) Int. Cl. H05B 33/00; H01J 40/14

(52) U.S. Cl. 250/484.4; 250/226

(57) ABSTRACT

A color conversion member of a high efficiency achieved by restraining fluorescence emitted from a certain phosphor from being absorbed again by another different phosphor, as well as a light emitting apparatus including the color conversion member are provided. The color conversion member includes N light transmissive members each containing a different one of N different phosphors illuminated with excitation light to emit fluorescence in a visible wavelength region, and the N light transmissive members are stacked in order (N is a natural number of not less than two). The color conversion member is designed in such a manner that the refractive index increases in the thickness direction while the fluorescence wavelength decreases in the thickness direction.

This nonprovisional application is based on Japanese Patent Application No. 2008-050180 filed on Feb. 29, 2008 with the Japan Patent Office, the entire contents of which are hereby incorporated by reference.

### BACKGROUND OF THE INVENTION

1. Field of the Invention

The present invention relates to a color conversion member containing a phosphor and to a light emitting apparatus using the color conversion member. More specifically, the invention relates to a color conversion member absorbing an excitation light of a short wavelength to emit light of a longer wavelength than the absorbed wavelength, and to a light emitting apparatus having a combination of the color conversion member and an excitation light source.

2. Description of the Background Art

Recently, a light emitting apparatus has been proposed that can generate a white light by mixing the light emitted from a light emitting diode device with the fluorescence that is emitted from a phosphor absorbing a part of the light from the diode device and that has a different wavelength from the wavelength of the light from the diode device.

Two examples may be given of such a light emitting apparatus using the method for generating a white light by combining a light emitting device and a phosphor. The first example is a light emitting apparatus using a method for generating a white light by causing a phosphor to absorb a part of the light emitted from a blue light emitting diode device serving as the light emitting device, and mixing the transmitted light from the light emitting device with the fluorescence from the phosphor. The second example is a light emitting apparatus using a method for generating a white light by employing a ultraviolet to blue-violet light emitting diode device as the light emitting device, and combining phosphors emitting a red fluorescence, a green fluorescence and a blue fluorescence respectively.

As the first example, a light emitting apparatus has already been brought into practical use that includes a combination of a blue light emitting diode device and a cerium-activated yttrium-aluminum-garnet-based yellow phosphor (see Japanese Patent Laying-Open No. 10-242513). This light emitting apparatus, however, has a problem that the spectrum of the white light generated by mixing colors has a relatively small amount of the red component and thus the color rendering is insufficient.

In view of this, a light emitting apparatus like the second example has been proposed with the color rendering improved by using respective phosphors of red, green and blue (see Japanese National Patent Publication No. 2000-509912). This light emitting apparatus, however, also has a problem that the red phosphor absorbs the fluorescence generated from the blue phosphor. This problem arises in the case where the emission spectrum of a certain phosphor and the absorption spectrum of another different phosphor overlap each other, and this phenomenon is likely to occur in the case where a plurality of different phosphors are mixed. A resultant problem is therefore that the light emitted from the light emitting apparatus is likely to exhibit color unevenness and the luminous efficiency is low.

Japanese Patent Laying-Open No. 2007-134656 for example discloses a technology for restraining the color unevenness and improving the luminous efficiency by disposing a red-emission phosphor which emits a long-wavelength fluorescence closer to a light emitting device than green- and blue-emission phosphors which emit short-wavelength fluorescence so as to restrain the red-emission phosphor from absorbing again the fluorescence generated from the green- and blue-emission phosphors.

### SUMMARY OF THE INVENTION

The above-described conventional methods, however, cannot sufficiently restrain degradation of the emission brightness of the light emitting apparatus due to the fact that the fluorescence generated from a certain phosphor is absorbed by another different phosphor. Since the phosphor isotropically emits fluorescence, the above-described structure cannot solve the problem that the fluorescence emitted from the green- and blue-emission phosphors toward the light emitting device is absorbed by the red-emission phosphor. Therefore, the resultant light emitting apparatus has a considerably low luminous efficiency and cannot be applied to a practical use.

In view of the above-described circumstances, the present invention has an object of providing a high-efficiency color conversion member achieved by restraining the fluorescence generated from a certain phosphor from being absorbed again by another different phosphor, and providing a light emitting apparatus including the color conversion member.

The inventor of the present invention has conducted intense and thorough studies for accomplishing the object to find that a color conversion member having a high external quantum efficiency can be obtained by dispersing phosphors emitting different fluorescence wavelengths, in light transmissive members with respective refractive indices different from each other, and accordingly complete the present invention.

Specifically, the present invention is a color conversion member including N light transmissive members stacked in order and each containing a different one of N different phosphors illuminated with an excitation light to emit fluorescence in a visible wavelength region, N is a natural number of not less than two, the N light transmissive members include a first light transmissive member having a refractive index of n1 and containing a first phosphor with a fluorescence wavelength of λ1 to an N-th light transmissive member having a refractive index of nN and containing an N-th phosphor with a fluorescence wavelength of λN that are stacked in order in a thickness direction, and the color conversion member simultaneously satisfies general expressions:

λ(M−1)≧λM (where M is an arbitrary natural number, M≦N) (1); and

n(M−1)<nM (where M is an arbitrary natural number, M≦N) (2).

Preferably, regarding the color conversion member of the present invention, the N-th light transmissive member is covered with a light transmissive member having a refractive index smaller than nN.

Preferably, regarding the color conversion member of the present invention, the phosphors have a particle size of not more than a wavelength of the excitation light.

Preferably, regarding the color conversion member of the present invention, the phosphors are semiconductor particles.

Preferably, regarding the color conversion member of the present invention, the phosphors contained in the color conversion member have a concentration distribution in a plane according to an optical path length of the excitation light.

Further, the present invention is a light emitting apparatus including a light emitting device emitting an excitation light and a color conversion member having N light transmissive members stacked in order and each containing a different one of N different phosphors emitting fluorescence in a visible wavelength region. In the color conversion member, N is a natural number of not less than two, and the N light transmissive members include a first light transmissive member having a refractive index of n1 and containing a first phosphor with a fluorescence wavelength of λ1 to an N-th light transmissive member having a refractive index of nN and containing an N-th phosphor with a fluorescence wavelength of λN that are stacked in order in a thickness direction, and the color conversion member simultaneously satisfies general expressions:

λ(M−1)≦λM (where M is an arbitrary natural number, M≦N) (3); and

n(M−1)<nM (where M is an arbitrary natural number, M≦N) (4).

Preferably, regarding the light emitting apparatus of the present invention, the light emitting device is a semiconductor light emitting diode device or semiconductor laser diode device.

Preferably, regarding the light emitting apparatus of the present invention, the light emitting device is a semiconductor laser diode device.

Preferably, regarding the light emitting apparatus of the present invention, the light emitting apparatus is structured such that a light transmissive member is located between the color conversion member and the light emitting device.

A high-efficiency color conversion member achieved by restraining the fluorescence emitted from a certain phosphor from being absorbed again by another different phosphor, as well as a light emitting apparatus including the color conversion member can be provided. This is for the reason that the color conversion member of the present invention can utilize the total reflection at the interface between the light transmissive members to restrain the fluorescence emitted from an N-th phosphor from being absorbed again by the N−1-th phosphor, so that the external quantum efficiency is improved.

The light emitting apparatus of the present invention exhibits excellent characteristics such as low-voltage drive, small size and lightweight, high durability and long life, and therefore, the apparatus is widely applicable to the backlight for the liquid crystal display and the illumination apparatus for example.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing an embodiment of a color conversion member of the present invention.

FIG. 2 is a cross section schematically showing an embodiment of a color conversion member of the present invention.

FIG. 3 is a diagram schematically showing an embodiment of a light emitting apparatus of the present invention.

FIG. 4 shows a schematic cross section of a color conversion member according to Example 1.

FIG. 5 shows a schematic cross section of a color conversion member according to Comparative Example 1.

FIG. 6 shows a schematic cross section of a color conversion member according to Example 3.

FIG. 7 shows a schematic cross section of a light emitting apparatus according to Comparative Example 2.

FIG. 8 shows a schematic cross section of a light emitting apparatus according to Example 5.

FIG. 9 shows a schematic cross section of a light emitting apparatus illustrating an example according to the present invention.

FIG. 10 shows a schematic cross section of a color conversion member according to Example 9.

### DESCRIPTION OF THE PREFERRED EMBODIMENTS

In the following, embodiments of the present invention will be described with reference to the drawings. Like or corresponding components in the drawings below are denoted by like reference characters, and a description thereof will not be repeated. Further, the dimensional relations such as length, magnitude and width in the drawings are appropriately changed for the sake of clarification and simplification of the drawings, and not scaled to represent the actual dimensions.

<Color Conversion Member>

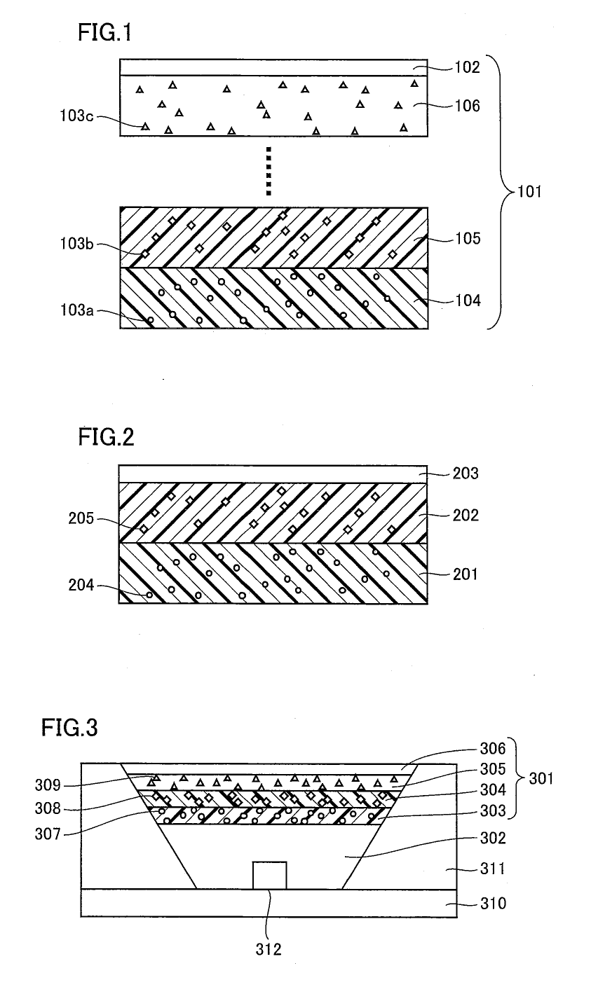

FIG. 1 is a diagram schematically showing an embodiment of a color conversion member of the present invention. FIG. 2 is a cross section schematically showing an embodiment of a color conversion member of the present invention.

A color conversion member according to the present invention will be described hereinafter with reference to FIGS. 1 and 2. As shown in FIG. 1, color conversion member 101 of the present invention includes N light transmissive members stacked in order and each containing a different one of N different phosphors illuminated with an excitation light to emit fluorescence in the visible wavelength region. Regarding color conversion member 101, N is a natural number of not less than two, and the N light transmissive members include a first light transmissive member 104 having a refractive index of n1 and containing a first phosphor 103a with a fluorescence wavelength of λ1, to an N-th light transmissive member 106 having a refractive index of nN and containing an N-th phosphor 103c with a fluorescence wavelength of λN that are stacked in order in the thickness direction from an excitation light source side. Color conversion member 101 of the present invention simultaneously satisfies the following general expressions (1) and (2).

λ(M−1)≧λM (where M is an arbitrary natural number, M≦N) (1)

n(M−1)<nM (where M is an arbitrary natural number, M≦N) (2)

Preferably, n1 is not less than 1.3 and nN is not more than 2.4. The refractive index of the light transmissive member may be measured by a method according to for example JIS K 7142 (1996 edition). Further, the fluorescence wavelength of the present invention may be measured with a fluorescence spectrometer.

While color conversion member 101 of the present invention is preferably illuminated with the excitation light from the first light transmissive member side, no problem arises even if the color conversion member is illuminated with the excitation light from the N-th light transmissive member side.

FIG. 1 shows that light transmissive member 104 containing first phosphor 103a and a light transmissive member 105 containing a second phosphor 103b are stacked in order in the thickness direction. Further, as described above, color conversion member 101 of the present invention is made up of at least two stacked light transmissive members containing at least two different phosphors respectively. Namely, the color conversion member of the present invention as shown in FIG. 2 includes, as a minimum unit, a light transmissive member 201 containing a first phosphor 204 and a light transmissive member 202 containing a second phosphor 205 stacked in order, and preferably second light transmissive member 202 is further covered with a light transmissive member 203 without containing a phosphor.

Regarding color conversion member 101 shown in FIG. 1, it is supposed here that respective wavelengths of the fluorescence emitted from first phosphor 103a and second phosphor 103b illuminated with the excitation light are λ1 and λ2, and there is the relation λ1≧λ2. In the case where the relation λ1=λ2 is satisfied, the first phosphor and the second phosphor have the same wavelength while the first and second phosphors are of different types. It is further supposed that respective refractive indices of first light transmissive member 104 and second light transmissive member 105 are n1 and n2, and there is the relation n1<n2. At this time, of the fluorescence emitted from second phosphor 103b toward first light transmissive member 104, a fluorescence component that is incident on the interface with a critical angle θc or more is reflected toward second light transmissive member 105 because of the total reflection. Here, critical angle θc for n1 and n2 is represented by mathematical expression (1).

θc=sin⁻¹(n2/n1) mathematical expression (1)

Thus, the fluorescence from second phosphor 103b can be restrained from being absorbed again by first phosphor 103a, and therefore, color conversion member 101 having this structure has a high external quantum efficiency. Here, the external quantum efficiency refers to the percentage that fluorescence photons are generated per excitation photon applied to the color conversion member. The external quantum efficiency is measured by a fluorescence spectrometer or integrating sphere for example. In this way, color conversion member 101 of the present embodiment can utilize the total reflection at the interface between the light transmissive members to restrain the fluorescence generated from an n-th phosphor from being absorbed again by the (n−1)-th phosphor.

A larger number N of light transmissive members constituting the above-described color conversion member is more preferable. This is for the reason that, when the number of light transmissive members containing respective phosphors is increased, the number of different phosphors contained in color conversion member 101 can be accordingly increased. The increased number of different phosphors contained in color conversion member 101 can improve the color rendering of the emission from color conversion member 101. It should be noted that a smaller number “N” of light transmissive members is more preferable in terms of the cost. In view of these facts, it is most preferable that the number “N” of light transmissive members constituting color conversion member 101 has a value of not less than 2 and not more than 5.

The N-th light transmissive member 106 is preferably covered with a light transmissive member 102 with a refractive index smaller than nN. For example, in FIG. 1, refractive index nN of the N-th light transmissive member 106 and refractive index n (N+1) of light transmissive member 102 satisfy the relation nN>n (N+1).

In the case where light is radiated from the N-th light transmissive member 106 having a larger refractive index to the outside such as air having a smaller refractive index, the light emitted at an angle of not less than critical angle θc as shown in the above mathematical expression (1) undergoes total reflection to be confined in the N-th light transmissive member 106, and therefore does not contribute to light emission from the color conversion member but results in a loss. The N-th light transmissive member 106 can be covered, however, with a material like light transmissive member 102 whose refractive index is smaller than that of the N-th light transmissive member and larger than that of the air to achieve the effect of facilitating emission of light from the N-th light transmissive member 106. In other words, the total reflection at the interface between color conversion member 101 and the air can be restrained to reduce the light propagating in the opposite direction to light transmissive member 102 in the color conversion member, and thereby efficiency extract light from color conversion member 101.

The above-described effect of the total reflection of the present invention occurs on the fluorescence emitted from the phosphor. Further, the fluorescence emitted from the phosphor does not change depending on the direction in which the excitation light is applied. Therefore, even if the excitation light is applied from the N-th light transmissive member 106 side, the total reflection still occurs so that the effect of improving the luminous efficiency of the light emitting apparatus can be achieved. In the case where the light emitting apparatus is designed to apply the excitation light from the N-th light transmissive member 106 side, the effect of providing a wide variety of design choices is obtained.

Further, an effect of further improving the external quantum efficiency is achieved by making the particle size of the phosphor contained in the light transmissive member equal to or less than the wavelength of the excitation light. This is for the reason that diffraction scattering of the excitation light due to phosphor particles does not occur when the phosphor particle size is equal to or less than that of the excitation light, so that a scattering loss of the excitation light can be reduced.

Further, the phosphor contained in color conversion member 101 may have a concentration distribution in the plane (in the plane perpendicular to the thickness direction in FIG. 1) according to the optical path length of the excitation light. In the case where the excitation light is incident on color conversion member 101 at a certain angle, the length of the optical path in color conversion member 101 through which the excitation light passes varies depending on the angle of incidence. Therefore, the absorptance of the excitation light of the phosphor also varies depending on the angle of incidence. Here, the phosphor concentration distribution in the plane can be varied to correct the difference of the absorptance of the phosphor depending on the optical path length, and accordingly the color unevenness can be improved.

Further, this color conversion member 101 may be used as an independent member. Alternatively, color conversion member 101 may be laid on a support substrate. For example, color conversion member 101 may be laid on a surface of a support substrate such as glass or paper, and an arbitrary optical function may be added to the support substrate, or the color conversion member may be laid on a surface of a light guide plate for use as a surface emitting member.

When the excitation light is applied to color conversion member 101, the N different phosphors contained in color conversion member 101 absorb the excitation light to emit respective fluorescence components. Therefore, the light emitted from color conversion member 101 is color-mixed light of the excitation light and the fluorescence components. Therefore, the white light can be used that is generated for example by combining a blue excitation light with green and red fluorescence components, or combining an ultraviolet to blue-violet excitation light with blue, green and red fluorescence components.

<<Material for Light Transmissive Member>>

The material for the light transmissive member of the present invention is desired to have the capability to keep the phosphor dispersed in the material, and have the characteristic that the material is transparent to the wavelength of the excitation light and the wavelength of the fluorescence emitted from the phosphor. Further, the light transmissive member is required to serve as a protection member for the phosphor. It is therefore particularly preferable that the material is opaque to oxygen and moisture. In the case where the light transmissive member is disposed near the light emitting device, the material for the light transmissive member is required to have heat resistance. Examples of the material for the light transmissive member satisfying the above-described conditions include resins such as silicone resin, epoxy resin, acrylic resin, fluorocarbon resin, polycarbonate resin, polyimide resin and urea resin, and a light transmissive inorganic material such as glass, alumina and yttria.

<<Phosphor>>

The phosphor of the present invention is desired to have the characteristic that the phosphor illuminated with at least a part of the excitation light absorbs the excitation light to generate fluorescence of a different wavelength from the excitation light. Further, the phosphor is required to have light resistance because the phosphor receives the intense excitation light, as well as durability against moisture and oxygen depending on the environment in use. In the case where the phosphor is disposed in the vicinity of the light emitting device, preferably the phosphor has good temperature characteristics. Examples of the phosphor material satisfying the above-described conditions include rare-earth-activated phosphor and semiconductor particle as described below.

Examples of the rare-earth-activated phosphor emitting blue light include BaMgAl₁₀O₁₇:Eu, (Ca, Sr, Ba)₅(PO₄)₃Cl:Eu, (Ca, Sr, Ba)₂B₅O₉Cl:Eu, (Sr, Ca, Ba)Al₂O₄:Eu or (Sr, Ca, Ba)₄Al₁₄O₂₅:Eu for example.

Examples of the rare-earth-activated phosphor emitting green light include SrAl₂O₄:Eu, Ca₃(Sc, Mg)₂Si₃O₁₂:Ce, BaMgAl₁₀O₁₇:Eu, Mn, (Mg, Ca, Sr, Ba)Si₂O₂N₂:Eu, (Ba, Ca, Sr)₂SiO₄:Eu for example.

Examples of the rare-earth-activated phosphor emitting yellow light include ((Y, Gd)₁₋ₓSmₓ)₃(Al_{y}Ga_{1-y})₅O₁₂:Ce (where x and y are each a number of not more than 1), (Ca, Mg, Y)ₓSi₁₂₋₍ₘ₊ₙ₎Al₍ₘ₊ₙ₎OₙN₁₆₋ₙ:Eu for example.

Examples of the rare-earth-activated phosphor emitting red light include CaAlSiN₃:Eu, (Mg, Ca, Sr, Ba)₂Si₅N₈:Eu, (Y, La, Gd, Lu)₂O₂S:Eu for example.

The semiconductor particle refers to a semiconductor microcrystal having a particle size of approximately several nm. When the size of a semiconductor crystal is decreased to approximately several nm, the band gap changes due to the quantum confinement effect. Therefore, the particle size can be controlled to control the emission wavelength. Because of the fact that the material is a semiconductor, the range of electron levels extends in the shape of a band, and thus light absorption occurs over a wide wavelength range. The semiconductor particle therefore exhibits remarkably excellent characteristics as a phosphor in terms of the selectivity of the fluorescence wavelength and in that the excitation wavelength is not limited to a particular one. Further, because of the fact that almost no light scattering due to semiconductor particles occurs, the scattering loss of the excitation light can be considerably reduced. Therefore, an effect of further improving the external quantum efficiency can be achieved. Here, such a semiconductor particle is also referred to as colloidal particle, nanoparticle or quantum dot for example in some cases.

Examples of the material for the semiconductor particle include group I-VII compound semiconductors composed of group I elements such as copper (Cu), silver (Ag), gold (Au) for example and group VII elements such as fluorine (F), chlorine (Cl), bromine (Br), iodine (I) for example, group II-VI compound semiconductors composed of group II elements such as zinc (Zn), cadmium (Cd), mercury (Hg) for example and group VI elements such as oxygen (O), sulfur (S), selenium (Se), tellurium (Te) for example, group III-V compound semiconductors composed of group III elements such as aluminum (Al), gallium (Ga), indium (In) for example and group V elements such as nitrogen (N), phosphorus (P), arsenic (As), antimony (Sb) for example, group IV semiconductors such as carbon (C), silicon (Si), germanium (Ge), tin (Sn), lead (Pb) for example, and group IV-VI compound semiconductors composed of group IV elements such as carbon (C), silicon (Si), germanium (Ge), tin (Sn), lead (Pb) for example and group VI elements such as oxygen (O), sulfur (S), selenium (Se), tellurium (Te) for example, and mixed crystals thereof.

Of these semiconductors, zinc selenide (ZnSe), zinc telluride (ZnTe), cadmium selenide (CdSe), cadmium telluride (CdTe), gallium nitride (GaN), indium nitride (InN), indium phosphide (InP), gallium arsenide (GaAs), copper chloride (CuCl), lead sulfide (PbS), lead selenide (PbSe), and mixed crystals thereof exhibit particularly excellent characteristics as a phosphor, because the semiconductor particles with the band gap increased by the quantum confinement effect emit visible light.

The phosphor of the present invention, however, is not limited to the above-listed substances. For example, an organic dye which is typically rhodamine B, an organic fluorescent pigment or the like may be used.

<<Application of Color Conversion Member>>

The color conversion member of the present invention is excellent in transparency and mechanical strength, and has excellent light absorption characteristics, light emission characteristics and external quantum efficiency. The color conversion member is used in various optical applications such as a UV absorption film provided on a surface of a windowpane or the like, an optical color filter used for a display or the like for the purpose of wavelength conversion, or a light emitting apparatus where the color conversion member is combined with an incandescent bulb, fluorescent bulb, cold-cathode tube, or semiconductor light emitting device and the emission wavelength can be selected.

<Light Emitting Apparatus>

FIG. 3 is a diagram schematically showing an embodiment of a light emitting apparatus of the present invention.

A description will be given hereinafter with reference to FIG. 3.

The light emitting apparatus of the present embodiment includes a light emitting device 312 emitting an excitation light, and a color conversion member 301 having N light transmissive members stacked in order from the excitation light source side and each containing a different one of N different phosphors which emit fluorescence in the visible wavelength region (N is a natural number of not less than two). Color conversion member 301 has a structure where the light transmissive members are stacked in the thickness direction, in the order of a first light transmissive member 303 having a refractive index of n1 and containing a first phosphor 307 with a fluorescence wavelength of λ1, a second light transmissive member 304 having a refractive index of n2 and containing a second phosphor 308 with a fluorescence wavelength of λ2 and a third light transmissive member 305 having a refractive index of n3 and containing a third phosphor 309 with a fluorescence wavelength of λ3. In the light emitting apparatus of the present invention, N light transmissive members may be stacked in the thickness direction to the N-th light transmissive member having a refractive index of nN and containing the N-th phosphor with a fluorescence wavelength of λN, further to third light transmissive member 305 containing third phosphor 309.

The color conversion member containing the phosphors simultaneously satisfies the following general expressions (3) and (4).

λ(M−1)≧λM (where M is an arbitrary natural number, M≦N) (3)

n(M−1)<nM (where M is an arbitrary natural number, M≦N) (4)

The light emitting apparatus shown in FIG. 3 has a structure where light emitting device 312 is attached on a substrate 310. On substrate 310, a reflection member 311 is also attached to surround light emitting device 312. The excitation light is emitted from light emitting device 312 and a part of the excitation light propagates in the lateral direction to be reflected upward by reflection member 311 and incident on light transmissive member 303. In this way, the excitation light emitted from light emitting device 312 can be made incident on color conversion member 301 efficiently. In FIG. 3, a light transmissive member 302 without containing phosphor is disposed to cover light emitting device 312, and color conversion member 301 is disposed to cover this light transmissive member. Thus, light transmissive member 302 can be inserted between light emitting device 312 and color conversion member 301 to provide the light emitting apparatus of a long life. This is for the reason that the influence of heat generation from light emitting device 312 on each phosphor is alleviated by light transmissive member 302. It should be noted here that color conversion member 301 may directly cover light emitting device 312. Specifically, first light transmissive member 303 may be disposed instead of light transmissive member 302, and second light transmissive member 304 and third light transmissive member 305 may be disposed in order in the thickness direction on the first light transmissive member.

The excitation light emitted from light emitting device 312 is incident on color conversion member 301 directly or after being reflected from reflection member 311. First phosphor 307, second phosphor 308 and third phosphor 309 contained in color conversion member 301 absorb the excitation light to emit respective fluorescence components. The light emitted from the light emitting apparatus is therefore the color-mixed light which is a mixture of respective fluorescence components from the phosphors and the light from light emitting device 312.

The surface of substrate 310 is more preferably mirror-finished to have the reflection capability. Since the fluorescence emitted from each phosphor toward substrate 310 and the excitation light scattered due to each phosphor are reflected from the surface of substrate 310, the intensity of light emission extracted from the light emitting apparatus can be increased.

Since the color of light emitted from the light emitting apparatus can be adjusted using the amounts of phosphors in color conversion member 301, the light emitting apparatus here is advantageous over a light emitting apparatus combining light emitting devices with respective emission wavelengths.

<<Light Emitting Device>>

Light emitting device 312 of the present invention is required to emit the light in a wavelength range absorbed by first phosphor 307, second phosphor 308 and third phosphor 309 contained in the color conversion member. Any light emitting device may be used as long as the device meets the above-described condition. Examples of the light emitting device include for example ultraviolet lamp, cold-cathode tube, semiconductor light emitting device, organic electroluminescence device, and inorganic electroluminescence device. Since the semiconductor light emitting device has an excellent monochromatic emission peak wavelength, the semiconductor light emitting device is particularly preferable in that the device can efficiently excite the phosphor.

In addition to light emitting device 312 emitting the excitation light for the phosphor, a light emitting device emitting light in a long wavelength region that does not excite the phosphor may be used together. Specifically, a light emitting device emitting red light that is not absorbed by the phosphor may be additionally disposed together with the light emitting device emitting ultraviolet to blue-violet light. The red light emitted from the light emitting device is not absorbed by each phosphor but discharged to the outside. Therefore, the light emitting device can be added to improve the color rendering of the emission from the light emitting apparatus.

A semiconductor light emitting diode device or semiconductor laser diode device can be used as light emitting device 312 to provide a light emitting apparatus with high luminous efficiency. This is for the reason that the emission wavelength of the semiconductor light emitting device can be controlled by means of the semiconductor material for the active layer, and thus an excitation light source that conforms to the absorption characteristic of the phosphor can be provided. Further, the light emitting apparatus of low voltage drive, small size and lightweight, high durability and long life can be provided.

Further, a semiconductor laser diode device can be used as light emitting device 312 to provide a light emitting apparatus of high luminous efficiency. This is for the reason that the high-directivity light from the semiconductor laser diode device can be used as the excitation light to confine the excitation light within the color conversion member through total reflection, so that a loss of the excitation light can be restrained.

<<Application of Light Emitting Apparatus>>

The light emitting apparatus of the present invention exhibits excellent characteristics such as low voltage drive, small size and lightweight, high durability, and long life for example, so that the light emitting apparatus can be applied widely to optical apparatuses such as backlight for the liquid crystal display, display apparatus and illumination apparatus for example. Further, a plurality of such light emitting apparatuses may be combined to be connected to a drive circuit for use as a display apparatus.

The present invention will be described hereinafter in more detail in connection with examples. The present invention, however, is not limited to them.

### EXAMPLES

In the following examples and comparative examples, a silicone resin, an acrylic resin and an epoxy resin with respective refractive indices of 1.45, 1.49 and 1.59 were used as materials for light transmissive members. Each refractive index of the material for the light transmissive member was measured in accordance with JIS K 7142 (1996 edition).

Further, unless otherwise stated, rare-earth activated phosphors CaAlSiN₃:Eu, Ca₃(Sc, Mg)₂Si₃O₁₂:Ce, SrAl₂O₄:Eu, and BaMgAl₁₀O₁₇:Eu having respective average particle sizes of 30, 17, 21, and 20 μm were used in the following examples.

### Example 1

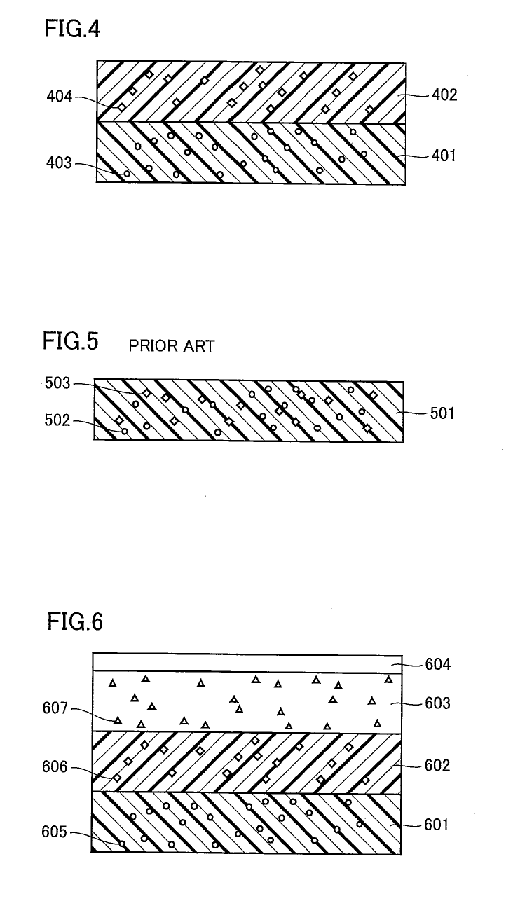

FIG. 4 shows a schematic cross section of a color conversion member according to Example 1, which will be described hereinafter with reference to FIG. 4.

The color conversion member of the present example includes a first light transmissive member 401 containing a first phosphor 403 illuminated with an excitation light to emit a red fluorescence, and a second light transmissive member 402 containing a second phosphor 404 illuminated with an excitation light to emit a green fluorescence, and the first and second light transmissive members are stacked in order. A method for manufacturing the color conversion member will be described.

First, a slurry was prepared by sufficiently mixing a silicone resin (refractive index 1.45) with 1.4% by mass, with respect to the silicone resin, of CaAlSiN₃:Eu, namely first phosphor 403 emitting a red fluorescence with a wavelength of 651 nm. The slurry was then poured into a plate-like mold. After poured, the slurry was heated at 150° C. for three hours to cure the silicone resin. In this way, first light transmissive member 401 containing first phosphor 403 was formed.

Likewise, a slurry was prepared by sufficiently mixing an epoxy resin (refractive index 1.59) with 6.9% by mass, with respect to the epoxy resin, of Ca₃(Sc, Mg)₂Si₃O₁₂:Ce, namely second phosphor 404 emitting a green fluorescence with a wavelength of 512 nm. The slurry was then poured onto first light transmissive member 401, and heated at 120° C. for an hour to be cured. In this way, second light transmissive member 402 containing second phosphor 404 was formed.

The color conversion member thus obtained was excited with light having a wavelength of 450 nm applied in the direction from first light transmissive member 401. It was confirmed that a white light with chromaticity coordinates x=0.30, y=0.30 measured in accordance with JIS Z 8701 was emitted. It was also confirmed that the external quantum efficiency measured using an integrating sphere was 14.56%. This external quantum efficiency was found higher than that of the color conversion member illustrated in connection with Comparative Example 1 described below.

### Comparative Example 1

FIG. 5 shows a schematic cross section of the color conversion member according to Comparative Example 1, which will be described hereinafter with reference to FIG. 5.

In connection with the comparative example, as a conventional example relative to Example 1, the color conversion member was considered where two different phosphors emitting a red fluorescence and a green fluorescence respectively were contained in the same light transmissive member.

As phosphors 502 and 503 respectively, red emission phosphor CaAlSiN₃:Eu with an emission wavelength of 651 nm, and green emission phosphor Ca₃(Sc, Mg)₂Si₃O₁₂:Ce with an emission wavelength of 512 nm were used. As light transmissive member 501, an epoxy resin (refractive index 1.59) was used. With respect to the epoxy resin, 1.4% by mass of the red emission phosphor and 6.9% by mass of the green emission phosphor were contained. A similar method to Example 1 was used to produce the color conversion member.

The color conversion member thus obtained was excited with light having a wavelength of 450 nm applied in the direction from first light transmissive member 401. Chromaticity coordinates were x=0.33, y=0.24 and a displacement from the white light was observed. This is due to the fact that a part of the emission from the green emission phosphor Ca₃(Sc, Mg)₂Si₃O₁₂:Ce is absorbed again by the red emission phosphor CaAlSiN₃:Eu. It was confirmed that the external quantum efficiency measured using an integrating sphere was 13.07%.

### Example 2

Example 2 will be described hereinafter with reference to above-described FIG. 2. In connection with the present example, a description will be given of a color conversion member having a stack structure made up of two different light transmissive members with different refractive indices respectively where one of the light transmissive members having a larger refractive index than the other is covered with another light transmissive member having a smaller refractive index than the aforementioned larger refractive index.

As first phosphor 204, red emission phosphor CaAlSiN₃:Eu with an emission wavelength of 651 nm was used and, as second phosphor 205, green emission phosphor Ca₃(Sc, Mg)₂Si₃O₁₂:Ce with an emission wavelength of 512 nm was used. A silicone resin (refractive index 1.45) was used for first light transmissive member 201, and an epoxy resin (refractive index 1.59) was used for second light transmissive member 202. A similar method to Example 1 was used to produce a stack structure of the light transmissive members. The silicone resin was poured onto light transmissive member 202 and heated at 150° C. for three hours to be cured, so that light transmissive member 203 was formed.

The color conversion member thus obtained was excited with light having a wavelength of 450 nm. White light emission with chromaticity coordinates x=0.30, y=0.30 was confirmed. The external quantum efficiency measured using an integrating sphere of 14.91% was also confirmed. This external quantum efficiency is higher than that of the color conversion member illustrated in Example 1, since the covering with light transmissive member 203 improves the light extraction efficiency from the color conversion member.

### Example 3

FIG. 6 shows a schematic cross section of a color conversion member according to Example 3, which will be described hereinafter with reference to FIG. 6.

Red emission phosphor CaAlSiN₃:Eu with an emission wavelength of 651 nm was used as a first phosphor 605, green emission phosphor SrA₂O₄:Eu with an emission wavelength of 518 nm was used as a second phosphor 606, and blue emission phosphor BaMgAl₁₀O₁₇:Eu with an emission wavelength of 450 nm was used as a third phosphor 607.

As a first light transmissive member 601, a second light transmissive member 602, a third light transmissive member 603, and a light transmissive member 604, a silicone resin (refractive index 1.45), an acrylic resin (refractive index 1.49), an epoxy resin (refractive index 1.59), and a silicone resin (refractive index 1.45) were used respectively. A similar method to Example 1 was used to produce a color conversion member.

The color conversion member thus obtained was excited with light having a wavelength of 405 nm applied in the direction from first light transmissive member 601. White light emission with chromaticity coordinates x=0.30, y=0.30 was confirmed. The external quantum efficiency measured using an integrating sphere of 13.61% was also confirmed.

### Example 4

The following light emitting apparatuses of Examples 4 to 9 were all prepared with respective amounts of different phosphors adjusted so that the chromaticity coordinates of the emission color fall in the ranges of 0.28<x<0.32 and 0.28<y<0.32.

Example 4 will be described hereinafter with reference to above-described FIG. 3. In connection with the present example, a description will be given of a light emitting apparatus that includes a blue-violet light emitting diode device as well as a color conversion member formed of a stack of a third light transmissive member containing a third phosphor emitting a blue fluorescence, a second light transmissive member containing a second phosphor emitting a green fluorescence and a first light transmissive member containing a first phosphor emitting a red fluorescence.

As light emitting device 312, the blue-violet light emitting diode device having an active layer of an InGaN compound semiconductor with an emission peak of 405 nm was used, and the light emitting device was secured onto substrate 310. On substrate 310, reflection member 311 was attached to surround light emitting device 312.

First, a silicone resin (refractive index 1.45) was poured onto substrate 310 to which light emitting device 312 was attached. After poured, the silicone resin was heated at 150° C. for three hours to be cured, so that light transmissive member 302 was formed.

A slurry was prepared by sufficiently mixing a silicone resin (refractive index 1.45) with CaAlSiN₃:Eu with an emission wavelength of 651 nm. The slurry was poured onto light transmissive member 302 and heated at 150° C. for three hours to be cured, so that light transmissive member 303 containing first phosphor 307 was formed.

Likewise, a slurry was prepared by sufficiently mixing an acrylic resin (refractive index 1.49) with green emission phosphor SrAl₂O₄:Eu having an emission wavelength of 518 nm. The slurry was poured onto first light transmissive member 303 and heated to be cured, so that second light transmissive member 304 containing second phosphor 308 was formed.

Likewise, a slurry was prepared by sufficiently mixing an epoxy resin (refractive index 1.59) with blue emission phosphor BaMgAl₁₀O₁₇:Eu having an emission wavelength of 450 nm. The slurry was poured onto second light transmissive member 304 and heated at 120° C. for an hour to be cured, so that third light transmissive member 305 containing third phosphor 309 was formed.

On third light transmissive member 305, a silicone resin (refractive index 1.45) was poured and heated at 150° C. for three hours, so that light transmissive member 306 was formed.

It was confirmed that the light emitting apparatus thus obtained had an improved luminous efficiency of 1.12 times that of a light emitting apparatus of Comparative Example 2 described below in which two different phosphors are contained in the same light transmissive member. This is for the reason that the light transmissive members having respective refractive indices different from each other and containing respective dispersed phosphors with different fluorescence wavelengths are stacked, so that the fluorescence emitted from a certain phosphor is restrained from being absorbed again by another different phosphor by means of the total reflection. Further, it was confirmed that the light emitting apparatus of the present example had an improved luminous efficiency of 1.02 times that of a light emitting apparatus of Example 4 in which light transmissive member 306 is not provided. This is for the reason that light transmissive member 306 having a low refractive index covers the outer side of third light transmissive member 305 to restrain the total reflection at the interface between color conversion member 301 and the air, and to improve the light extraction efficiency from color conversion member 301.

Further, a life test with temperature 25° C. and 100 mA energization and a life test with temperature 25° C. and 50 mA energization were conducted. Any change due to the phosphor was not observed. It was confirmed that the life characteristic of the light emitting apparatus of the present example and that of light emitting device 312 alone are substantially identical to each other.

### Comparative Example 2

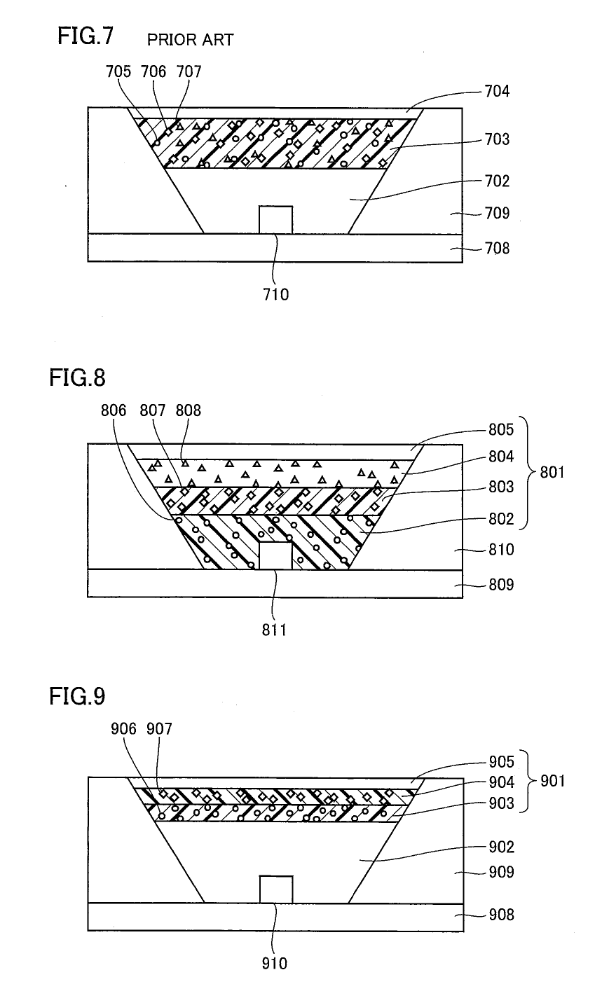

FIG. 7 shows a schematic cross section of a light emitting apparatus according to Comparative Example 2, which will be described hereinafter with reference to FIG. 7.

In connection with the present comparative example, as a conventional example relative to Example 4, a light emitting apparatus was considered that includes a blue-violet light emitting diode device and a color conversion member where three different phosphors emitting a red fluorescence, a green fluorescence and a blue fluorescence respectively are contained in the same light transmissive member.

As a light emitting device 710, a blue light emitting diode device having an active layer of an InGaN compound semiconductor with an emission peak of 405 nm was used. As phosphors 705, 706 and 707 respectively, red emission phosphor CaAlSiN₃:Eu with an emission wavelength of 651 nm, green emission phosphor SrAl₂O₄:Eu with an emission wavelength of 518 nm and blue emission phosphor BaMgAl₁₀O₁₇:Eu with an emission wavelength of 450 nm were used. For light transmissive members 702, 703 and 704 respectively, a silicone resin (refractive index 1.45), a silicone resin (refractive index 1.45) and an epoxy resin (refractive index 1.59) were used. A similar method to Example 4 was used to produce a light emitting apparatus. Here, with respect to the silicone resin forming light transmissive member 703, 0.8% by mass of the red emission phosphor, 3.3% by mass of the green emission phosphor and 5.9% by mass of the blue emission phosphor were contained.

### Example 5

FIG. 8 shows a schematic cross section of a light emitting apparatus according to Example 5, which will be described hereinafter with reference to FIG. 8. In connection with the present example, a description will be given of the light emitting apparatus including a blue light emitting diode device and a color conversion member 801 in which three different phosphors emitting a red fluorescence, a green fluorescence and a blue fluorescence are contained in respective three different light transmissive members.

As a light emitting device 811, a blue light emitting diode device having an active layer of an InGaN compound semiconductor with an emission peak of 405 nm was used. As a first phosphor 806, a second phosphor 807 and a third phosphor 808 respectively, red emission phosphor CaAlSiN₃:Eu with an emission wavelength of 651 nm, green emission phosphor SrAl₂O₄:Eu with an emission wavelength of 518 nm and blue emission phosphor BaMgAl₁₀O₁₇:Eu with an emission wavelength of 450 nm were used. As a first light transmissive member 802, a second light transmissive member 803, a third light transmissive member 804, and a light transmissive member 805 respectively, a silicone resin (refractive index 1.45), an acrylic resin (refractive index 1.49), an epoxy resin (refractive index 1.59), and a silicone resin (refractive index 1.45) were used. A similar method to Example 4 was used to produce a light emitting apparatus.

Appropriate adjustments were made so that 0.8% by mass of first phosphor 806 was contained with respect to first light transmissive member 802, 3.0% by mass of second phosphor 807 was contained with respect to second light transmissive member 803, and 4.5% by mass of third phosphor 808 was contained with respect to third light transmissive member 804.

The light emitting apparatus thus obtained had a substantially identical luminous efficiency to the light emitting apparatus of Example 4. A life test was conducted and a decrease of the output was found relative to Example 4. An analysis was performed. As a result, discoloration of the phosphor was found. It was considered that the discoloration was caused by degradation of the phosphor due to heat generated from the light emitting device.

### Example 6

FIG. 9 shows a schematic cross section of a light emitting apparatus illustrating an example according to the present invention, which will be described hereinafter with reference to FIG. 9. In connection with the present example, a description will be given of the light emitting apparatus including a blue light emitting diode device and a color conversion member 901 where two different phosphors emitting a red fluorescence and a green fluorescence respectively are contained in two different light transmissive members respectively.

As light emitting device 910, the blue light emitting diode device having an active layer of an InGaN compound semiconductor with an emission peak of 450 nm was used. As a first phosphor 906 and a second phosphor 907 respectively, red emission phosphor CaAlSiN₃:Eu with an emission wavelength of 651 nm and green emission phosphor Ca₃(Sc, Mg)₂Si₃O₁₂:Ce with an emission wavelength of 512 nm were used. As a light transmissive member 902, a first light transmissive member 903, a second light transmissive member 904, and a light transmissive member 905 respectively, a silicone resin (refractive index 1.45), a silicone resin (refractive index 1.45), an epoxy resin (refractive index 1.59), and silicone resin (refractive index 1.45) were used. A similar method to Example 4 was used to produce the light emitting apparatus. Appropriate adjustments were made so that 1.4% by mass of first phosphor 906 was contained with respect to first light transmissive member 903, and 6.9% by mass of second phosphor 907 was contained with respect to second light transmissive member 904.

### Example 7

Example 7 will be described hereinafter with reference to above-described FIG. 3. In connection with the present example, a description will be given of a light emitting apparatus including a blue-violet light emitting diode device and a color conversion member made up of light transmissive members having a concentration distribution of dispersed phosphors.

As light emitting device 312, a blue light emitting diode device having an active layer of an InGaN compound semiconductor with an emission peak of 405 nm was used. As first phosphor 307, second phosphor 308 and third phosphor 309 respectively, red emission phosphor CaAlSiN₃:Eu with an emission wavelength of 651 nm, green emission phosphor SrAl₂O₄:Eu with an emission wavelength of 518 nm and blue emission phosphor BaMgAl₁₀O₁₇:Eu with an emission wavelength of 450 nm were used. As light transmissive member 302, first light transmissive member 303, second light transmissive member 304, third light transmissive member 305, and light transmissive member 306 respectively, a silicone resin (refractive index 1.45), a silicone resin (refractive index 1.45), an acrylic resin (refractive index 1.49), an epoxy resin (refractive index 1.59), and a silicone resin (refractive index 1.45) were used. Five different slurries having different concentrations of phosphors mixed with resins were prepared. The slurry of the lowest concentration was poured in reflection member 311 and heated to be cured. Subsequently, the slurry of the second lowest concentration was poured in reflection member 311 such that the poured slurry abutted on the resin having heated to be cured. The above process was repeated so that the concentration of dispersed phosphors could be varied in the plane of the light transmissive members. In other words, first phosphor 307, second phosphor 308 and third phosphor 309 were dispersed in respective light transmissive members in such a manner that the concentration of the phosphors decreases as the distance from light emitting device 312 increases.

It was confirmed that the light emitting apparatus thus obtained exhibited less color unevenness depending on the light emission angle and the color of emission was uniform as compared with the light emitting apparatus of Example 4.

Appropriate adjustments were made so that 0.8% by mass of first phosphor 307 was contained with respect to first light transmissive member 303, 3.0% by mass of second phosphor 308 was contained with respect to second light transmissive member 304, and 4.5% by mass of third phosphor 309 was contained with respect to third light transmissive member 305.

### Example 8

FIG. 9 shows a schematic cross section of a light emitting apparatus illustrating an example according to the present invention, which will be described hereinafter with reference to FIG. 9.

As a light emitting device 910, a blue light emitting diode device having an active layer of an InGaN compound semiconductor with an emission peak of 450 nm was used. As a second phosphor 907 and a first phosphor 906 respectively, semiconductor particles of an InP semiconductor material (fluorescence wavelength 531 nm) with a particle size of 2.0 nm and semiconductor particles of an InP semiconductor material (fluorescence wavelength 635 nm) with a particle size of 3.0 m were used. As light transmissive member 902, a first light transmissive member 903, a second light transmissive member 904, and a light transmissive member 905 respectively, a silicone resin (refractive index 1.45), a silicone resin (refractive index 1.45), an epoxy resin (refractive index 1.59), and a silicone resin (refractive index 1.45) were used. A similar method to Example 4 was used to produce a light emitting apparatus. Appropriate adjustments were made so that 1.4% by mass of first phosphor 906 was contained with respect to first light transmissive member 903, and 6.9% by mass of second phosphor 907 was contained with respect to second light transmissive member 904.

It was confirmed that the light emitting apparatus thus obtained had an improved luminous efficiency of 1.03 times that of the light emitting apparatus of Example 6. The reason was considered as due to the smaller particle size of the phosphors reduced the scatter loss of the excitation light emitted from light emitting device 910 so that the emission from the light emitting device was efficiently extracted to the outside.

### Example 9

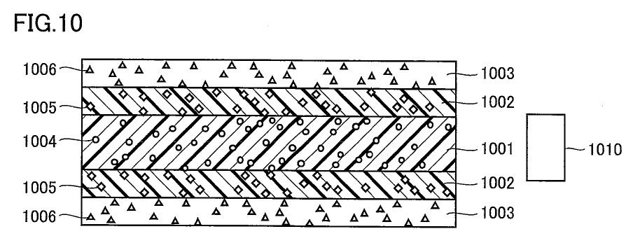

FIG. 10 shows a schematic cross section of a color conversion member according to Example 9, which will be described hereinafter with reference to FIG. 10.

A slurry was prepared by sufficiently mixing a silicone resin (refractive index 1.45) with semiconductor particles of an InP semiconductor material (fluorescence wavelength 635 nm) with a particle size of 3.0 nm. The slurry was poured into a cylindrical mold and heated to be cured, so that a first light transmissive member 1001 in which a first phosphor 1004 was dispersed was formed. Semiconductor particles of an InP semiconductor material (fluorescence wavelength 531 nm) with a particle size of 2.0 nm that were dispersed in an acrylic resin (refractive index 1.49) were applied to the surface of first light transmissive member 1001 to form a second light transmissive member 1002 in which a second phosphor 1005 was dispersed. Likewise, on second light transmissive member 1002, a third light transmissive member 1003 with a third phosphor 1006 dispersed therein was formed that was made up of CdSe semiconductor particles (fluorescence wavelength 481 nm) with a particle size of 1.9 nm and an epoxy resin (refractive index 1.59). The above-described method was used to produce a cylindrical color conversion member in which phosphors were concentrically dispersed as shown in FIG. 10. The emission from a semiconductor laser diode 1010 was applied as an excitation light from the bottom side of the cylindrical color conversion member. A semiconductor light emitting apparatus could be produced in this way.

The light emitting apparatus thus obtained had a luminous efficiency of 781 m/W. The emission from the semiconductor laser diode has a high directivity so that the emission is subjected to total reflection at the interface between light transmissive member 1003 and the atmosphere. Therefore, the excitation light is not emitted to the outside. It was thus confirmed that a higher luminous efficiency was achieved as compared with the light emitting apparatus of Example 4.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A color conversion member including N light transmissive members stacked in order and each containing a different one of N different phosphors illuminated with an excitation light to emit fluorescence in a visible wavelength region, wherein
N is a natural number of not less than two,
said N light transmissive members include a first light transmissive member having a refractive index of n1 and containing a first phosphor with a fluorescence wavelength of λ1 to an N-th light transmissive member having a refractive index of nN and containing an N-th phosphor with a fluorescence wavelength of λN that are stacked in order in a thickness direction, and
said color conversion member simultaneously satisfies general expressions:
λ(M−1)≧λM (where M is an arbitrary natural number, M≦N) (1); and
n(M−1)<nM (where M is an arbitrary natural number, M≦N) (2).

2. The color conversion member according to claim 1, wherein
said N-th light transmissive member is covered with a light transmissive member having a refractive index smaller than nN.

3. The color conversion member according to claim 1, wherein
said phosphors have a particle size of not more than a wavelength of said excitation light.

4. The color conversion member according to claim 3, wherein
said phosphors are semiconductor particles.

5. The color conversion member according to claim 1, wherein
said phosphors contained in said color conversion member have a concentration distribution in a plane according to an optical path length of the excitation light.

6. A light emitting apparatus comprising a light emitting device emitting an excitation light and a color conversion member including N light transmissive members stacked in order and each containing a different one of N different phosphors emitting fluorescence in a visible wavelength region, wherein
N is a natural number of not less than two,
said N light transmissive members include a first light transmissive member having a refractive index of n1 and containing a first phosphor with a fluorescence wavelength of λ1 to an N-th light transmissive member having a refractive index of nN and containing an N-th phosphor with a fluorescence wavelength of λN that are stacked in order in a thickness direction, and
said color conversion member simultaneously satisfies general expressions:
λ(M−1)≧λM (where M is an arbitrary natural number, M≦N) (3); and
n(M−1)<nM (where M is an arbitrary natural number, M≦N) (4).

7. The light emitting apparatus according to claim 6, wherein
said light emitting device is a semiconductor light emitting diode device or semiconductor laser diode device.

8. The light emitting apparatus according to claim 7, wherein
said light emitting device is a semiconductor laser diode device.

9. The light emitting apparatus according to claim 6, wherein
said light emitting apparatus is structured such that a light transmissive member is located between said color conversion member and said light emitting device.
